(19) United States
(12) Patent Application Publication
(10) Pub. No.: US 2001/0001477 A1
(43) Pub. Date: May 24, 2001

(54) ACTIVELY CONTROLLED VALVE FOR A PISTON COMPRESSOR

(76) Inventors: CYRILL STEINEBRUNNER, WINTERTHUR (CH); ERICH KLAUI, SEUZACH (CH)

Correspondence Address: J GEORG SEKA, TOWNSEND AND TOWNSEND AND CREW LLP, EIGHTH FLOOR, TWO EMBARCADERO CENTER, SAN FRANCISCO, CA, 941113834

(21) Appl. No.: 09/347,876

(22) Filed: Jul. 6, 1999

(30) Foreign Application Priority Data
Jul. 7, 1998 (EP) 98810640.7

(51) Int. Cl. F16K 31/04

(52) U.S. Cl. 251/129.02; 251/160; 251/129.11

(57) ABSTRACT

An actively controlled valve for a piston compressor comprises a valve plate (2) and a counter-plate (3), each of which has passage openings (21, 31). The valve plate (2) is journalled in such a manner that it is rotatable about the longitudinal axis (A) of the valve and relative to the counter-plate (3). A drive device (4) is provided which is rotationally fixedly connected to the valve plate (2) in order to rotate the latter relative to the counter-plate (3).

The invention relates to an actively controlled valve for a piston compressor in accordance with the preamble of the independent patent claim.

The suction and compression valves of piston compressors are mostly designed nowadays as spring loaded valves which are actuated by their specific medium, for example as plate valves. A plate valve of this kind typically comprises a plate-like valve seat, a valve plate and a plate-like valve cap which are arranged one behind the other when viewed in the axial direction of the valve and are held together by a central screw. In this the valve plate is arranged between the valve seat and the valve cap and is pressed by a bias force against the valve seat by springs which act between the valve cap and the valve plate so that it closes the passages in the valve seat sealingly. At a predeterminable opening pressure of the specific medium the valve plate is lifted off in the axial direction from the valve seat against the force of the springs and frees the passage for the medium. If the pressure of the specific medium drops below the closure pressure then the springs press the valve plate against the valve seat again and the valve closes.

Valves of this kind are thus passively actuated, which means that the movement of the valve plate or a similar valve body results substantially from the relationship of the forces which are caused by the specific medium, the springs and the masses. One of the main problems of valves of this kind is their unsatisfactory valve kinematics. They open and close slowly; the opening or closing time point respectively related to the work cycle of the piston compressor can be set only imprecisely and not ideally. If for example relatively weak springs are used, then the stroke of the valve plate is admittedly sufficiently large in order to realise a sufficient through-flow cross-section of the valve, but the valve closes too late or too slowly as a rule. If on the other hand stronger springs are chosen, then the valve admittedly closes more rapidly, but the stroke of the valve plate is significantly smaller, from which a disadvantageous reduction of the through-flow cross-section results.

Valves of this kind also tend to flow-excited oscillations, which are also designated as aeroelastic fluttering. In addition the valve plate frequently rebounds back at the end abutment. These uncontrolled rebound movements lead to material fatigue and damage, through which the lifetime of the valve or of the compressor respectively is significantly reduced. This is a considerable disadvantage from the economical point of view.

In addition, active valves, e.g. mushroom valves, are known in automobile engines from the prior art, that is, valves which are actuated by external control through a drive mechanism of their own. The actuation of active valves of this kind takes place for example via a cam drive and a correspondingly designed transmission linkage which control the stroke movement of the valve plate relative to the valve seat. Actively controlled plate valves have the advantage that no energy need be extracted from the flowing medium for the actuation of the valve. In addition valves of this kind can open and close more rapidly and the opening or closing time point respectively can as a rule be set more precisely than in passive valves. But the problem of the rebounding of the valve plate and the material abrasion resulting therefrom is also present in the known active valves.

In particular in the development of modern piston compressors with high performance, in which higher working speeds and higher difference pressures are frequently aimed at, this problem becomes ever more serious.

Starting from this prior art it is therefore an object of the invention to propose an actively controlled valve for a piston compressor which has an improved valve kinematics. In particular the rebounding of the valve plate should be avoided as far as possible.

The actively controlled valve satisfying these objects is characterised by the features of the independent claim.

In accordance with the invention an actively controlled valve is thus proposed for a piston compressor which comprises a valve plate and a counter-plate, each of which has passage openings, with the valve plate being journalled in such a manner that it is rotatable about the longitudinal axis of the valve and relative to the counter-plate. The valve further comprises a drive device which is rotationally fixedly connected to the valve plate in order to rotate the latter relative to the counterplate.

In the closure position of the valve in accordance with the invention the valve plate and the counter-plate are oriented relative to one another in such a manner that the passage openings in the counter-plate are closed by the valve plate. For the opening of the valve the valve plate is rotated by a predetermined angle relative to the counter-plate and about the longitudinal axis of the valve so that the passage openings in the valve plate come to lie over the passage openings in the counter-plate. In this way a through-going flow cross-section for the medium arises, that is, the valve is in its open position. For the closing of the valve the valve plate is likewise rotated by a predetermined angle about the longitudinal axis of the valve so that it sealingly closes the passage openings in-the counter-plate.

The opening or the closing respectively of the valve thus takes place in each case through a rotation of the valve plate relative to the base plate in order to bring the passage openings which are provided in each case in the two plates into alignment (open position) or, respectively, into such a mutual position that no through-going flow connection exists (closure position). Through this measure the problem of the rebound of the valve plate, such as occurs in known valves, is avoided. The known problem of the aeroelastic fluttering also no longer occurs in the valve in accordance with the invention.

In regard to a good valve kinematics, and in particular in regard to an opening or closing time point respectively which can be set as ideally as possible, the drive device is preferably an electrical drive with a stator and a rotor, with the rotor being rotationally fixedly connected to the valve plate. This drive represents a simple possibility of controlling the angular position of the valve plate relative to the counter-plate rapidly and with sufficient precision.

In order to enable an even more rapid opening or closing of the valve respectively, the rotor is preferably designed as a mass-poor rotor, in particular as a tubular rotor. Through this the masses which are moved in the actuation of the valve are small so that only comparatively low inertial forces arise.

In a particularly preferred embodiment means are provided at the valve in accordance with the invention in order to move the valve plate in the axial direction relative to the counter-plate. For the opening and closing of the valve the valve plate executes a combined lifting and rotating movement. In this the amplitude of the lifting movement is comparatively small, for example only about 0.1 mm. Through this slight movement in the axial direction in the actuation of the valve the valve plate can be rotated relative to the counter-plate substantially without friction. Through this practically no abrasion of the valve plate and the counter-plate takes place so that a very long lifetime of the valve is ensured.

The means for the movement of the valve plate in the axial direction can comprise a lifting magnet which is arranged in such a manner that it can exert an axially directed force on the valve plate and/or on the rotor. It is also possible to design the electrical drive in such a manner that it can exert an axially directed force on the valve plate.

The counter-plate, the valve plate and the rotor are advantageously arranged along a carrier element which extends in the axial direction, with the journalling of the valve plate and of the rotor with respect to the carrier element being designed to be abrasion-free, in particular frictionless. Through this abrasion-free journalling of the rotatable valve components, namely of the rotor and the valve plate, the lifetime of the valve plate can be increased still further because practically no wear through parts which slide along one another is present.

In a preferred embodiment this abrasion-free journalling is realised in that the valve plate and the rotor are connected to the carrier element by means of bending springs. The bending springs extend in the radial direction between the carrier element on the one hand and the valve plate or the rotor respectively on the other hand. When the valve is actuated, that is, when the valve plate is rotated, the bending springs are elastically deformed. Through the bending springs the valve plate or the rotor respectively is also journalled in an abrasion-free manner with respect to the axial direction so that the possibly additionally present slight lifting movement of the valve plate in the axial direction is likewise possible. This design, in which the valve plate is rotatably and axially movably journalled by means of bending springs, has the additional advantage that the journalling of the valve plate is also free from play, so that a reliable valve functioning is ensured.

Furthermore, it is also possible to journal the rotor magnetically and without contact with respect to the carrier element.

Further advantageous measures and preferred embodiments of the invention result from the subordinate claims.

The invention will be explained in the following in more detail with reference to the drawings and with reference to an exemplary embodiment. Shown in the schematic drawings, which are not to scale, are:

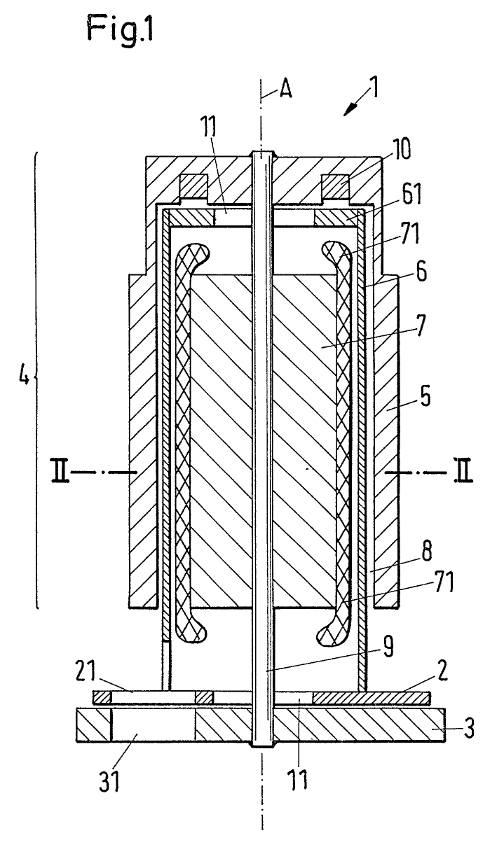

FIG. 1 a longitudinally sectioned illustration of an exemplary embodiment of the valve in accordance with the invention with the essential parts,

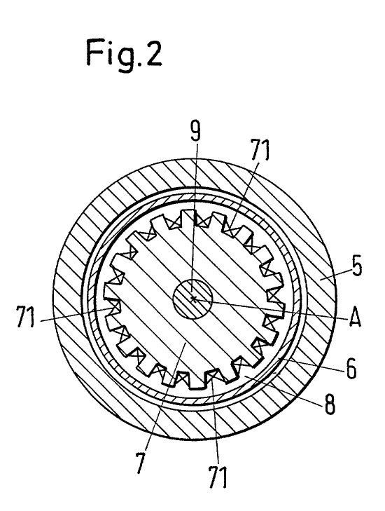

FIG. 2 a cross-section through the exemplary embodiment along the section line II-II in FIG. 1, and

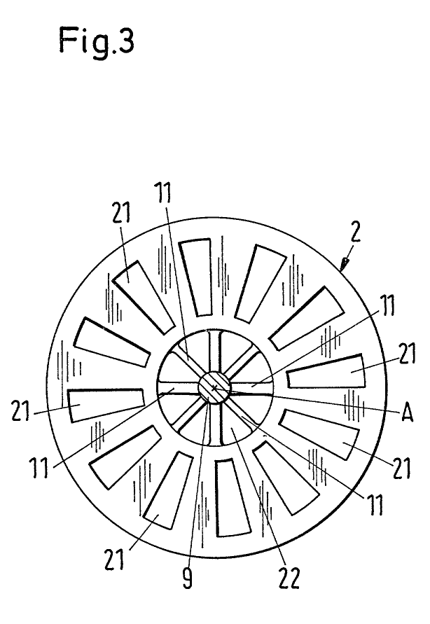

FIG. 3 a plan view of the valve plate of the exemplary embodiment.

FIG. 1 shows the essential parts of an exemplary embodiment of an actively controlled valve in accordance with the invention, which is designated in its entirety with the reference numeral 1, in a longitudinally sectioned illustration. The valve 1 is accommodated in a non-illustrated valve housing. The exemplary embodiment illustrated in FIG. 1 is designed as a pressure valve for a piston compressor. It is evident that the actively controlled valve 1 in accordance with the invention can also be analogously designed as a suction valve.

The active valve 1 comprises a valve plate 2, which is illustrated in FIG. 3 in a plan view, and a counter-plate 3. A plurality of passage openings 21 and 31 respectively, which are preferably formed in each case as radially extending slits and which are equidistantly distributed when viewed in the peripheral direction over the valve plate 2 and the counter-plate 3 respectively as shown in FIG. 3, are provided both in the valve plate 2 and in the counter-plate 3. In this the dimensions of the slits and their mutual spacing are the same on the valve plate 2 as on the counter-plate 3.

The counter-plate 3 is rigidly connected to a bar-shaped carrier element 9 which extends in the axial direction, by which the direction of the longitudinal axis A of the valve 1 is meant. In the normal operating state this carrier element 9 and thus also the counter-plate 3 is arranged at a fixed location with respect to the compressor housing. In the assembled state the counter-plate 3 is braced e.g. in a manner which is known per se in the housing of the compressor and thus carries the valve 1. In this the valve 1 is mounted in such a manner that the compression space of the compressor is located beneath the counter-plate 3 in the illustration (FIG. 1).

The valve plate 2 is arranged adjacently to the counter-plate 3 in the axial direction, above it in accordance with the illustration. In the closure position of the valve 1 the valve plate 2 lies sealingly on the counter-plate 3 and is supported by the latter.

The valve plate 2 is rotatably and axially movably journalled with respect to the carrier element 9 in the exemplary embodiment described here by means of bending springs 11. For this the valve plate 2 is designed in the shape of a ring, which means that it has a central opening 22 in the axial direction. The carrier element 9 extends through this central opening 22. The carrier element 9 is connected via a plurality of bending springs 11 to the radially inwardly lying boundary surface of the valve plate 2, with the bending springs 11 being arranged in each case in such a manner that they extend in the radial direction in their rest position. Thus the valve plate 2 is journalled in such a manner that it can be rotated about the longitudinal axis A of the valve 1 and relative to the counter-plate 3.

If the valve 1 is in its closure position, then the valve plate 2 is oriented with respect to the counter-plate 3 in such a manner that the regions between the passage openings 21 in the valve plate 2 lie over the passage openings 31 in the counter-plate 3 in accordance with the illustration so that the latter are covered by the valve plate 2. As a consequence the valve plate 2 lies sealingly on the counter-plate 3 and there is no through-going flow connection through the valve 1. To open the valve 1 the valve plate 2 is rotated about the longitudinal axis A of the valve 1 by a predetermined angle, which is substantially determined by the extension of a passage opening 21, 31 in the peripheral direction, so that the passage openings 31, 21 in the counter-plate 3 and in the valve plate 2 come into alignment. A through-going flow connection now exists.

Particularly advantageous in this embodiment is that the medium can flow through the valve practically without deflection and thus the flow losses, in particular the energy loss of the medium, are considerably less than in known valves.

The active valve in accordance with the invention is externally controlled by means of a drive apparatus 4. In the preferred exemplary embodiment the drive device is an electric drive 4 which is supplied with energy and controlled by a non-illustrated control and supply unit. In this the control takes place e.g. in dependence on the clocking of the piston movement of the piston compressor. The electric drive comprises, in a coaxial arrangement, a stator 7 with windings 71, a rotor 6 and a yoke 5, the common axis of which is the longitudinal axis A of the valve 1. For the clarification of this arrangement FIG. 2 shows a cross-section through the exemplary embodiment along the section line II-II in FIG. 1. In the exemplary embodiment described here the stator 7 is arranged to lie inwardly and is arranged on the carrier element 9. The stator 7 is surrounded by a sleeve-shaped, outwardly lying yoke 5 for the magnetic field which is likewise arranged on the carrier element 9. The rotor 6 of the electric drive 4, which is designed as a tubular rotor 6, is arranged in an air gap 8 between the stator 7 and the yoke 5. The rotor 6 is thereby low in mass so that only low inertial forces arise in the acceleration of the rotor 6. The advantage results therefrom that the valve 1 works very rapidly, and hence can be opened or closed respectively within a very short time.

The tubular rotor 6 is directly and rotationally fixedly connected at its one end (with respect to the axial direction) to the valve plate 2 so that the latter forms an axial end surface of the rotor 6. At its other axial end, the upper end in accordance with the illustration (FIG. 1), the rotor has a ring-disc-shaped part 61 on the carrier element 9 which forms the second axial boundary surface of the rotor 6 and which is journalled inside the yoke 5. The journalling of the ring-disc-shaped part 61 on the carrier element 9 is realised in a manner analogous to that explained above for the valve plate 2 by means of bending springs 11 so that the entire unit consisting of the rotor 6 and the valve plate 2 is rotatably and axially movably journalled on the carrier element 9.

The bending springs 11 are preferably arranged in such a manner that the valve 1 is open when the bending springs are in their rest or equilibrium position respectively. The advantage results therefrom that the valve 1 opens automatically in the event of a failure of the electric drive 4 and no inadmissibly high pressure arises in the compressor.

In a particularly preferred embodiment the valve 1 in accordance with the invention has means in order to move the valve plate 2 in the axial direction relative to the counter-plate 3. During the opening or closing of the valve 1 respectively the valve plate then executes a combined lifting-rotational movement, as will be explained further below, from which the advantage results that practically no abrasion arises at the counter-plate 3 and at the valve plate 2 through the actuation of the valve 3 because the rotational movement can take place without friction.

In the exemplary embodiment described here the means for moving the valve plate 2 in the axial direction comprise a ring-shaped lifting magnet 10 which is designed as an electromagnet and is likewise excited by the non-illustrated control and supply unit. The lifting magnet 10 is arranged in the axial end side of the yoke 5 so that it lies opposite to the ring-disc-shaped part 61 of the rotor 6. Through activation of the lifting magnet 10 the latter exerts an axially directed force on the rotor 6 and thus on the valve plate 2 so that the latter is lifted off from the counter-plate 3.

The preferred exemplary embodiment of the valve 1 functions as follows: If the valve 1 is in its open position, then the valve plate 2 is oriented with respect to the counter-plate 3, as already explained above, in such a manner that passage openings 31 in the counter-plate 3 and the passage openings 21 in the valve plate 2 lie over one another so that the medium can flow through the valve 1. To initiate the closure movement the control and supply unit first activates the lifting magnet 10, which then attracts the rotor 6 in the axial direction and thus lifts off the valve plate 2, which is connected to the rotor 6, from the counter-plate 3. In this movement the bending springs 11 are elastically deformed in the axial direction. The lifting movement typically has only a very small amplitude of for example 0.1 mm. It should ensure that the valve plate 2 is separated from the counter-plate 3 in order that the following rotational movement can take place without sliding and adhesive friction. After the valve plate 2 is separated from the counter-plate 3 the control and supply unit excites the electric drive 4 in such a manner that the rotor 6, and hence the valve plate 2, is rotated by a predetermined angle about the carrier element 9, with the angle being dimensioned in such a manner that the regions between the passage openings 21 in the valve plate 2 are located over the passage openings 31 in the counter-plate 3 after the rotation. In this rotational movement the bending springs 11 are elastically deformed in the peripheral direction. Then the lifting magnet 10 is deactivated and the valve plate 2 settles, assisted by the restoring force of the bending springs 1 1 in the axial direction, onto the counter-plate 3, the passage openings 31 of which are thereby sealingly covered over. The valve 1 is closed. To open the valve 1 the valve plate 2 is again first lifted in the axial direction by means of the lifting magnet 10, then rotated by the same angle as in the closure process but in the opposite direction, and then lowered in the axial direction so that it again lies on the counter-plate 3, however in such an orientation that the passage openings in the counter-plate 3 and in the valve plate 2 lie over one another.

Through the design of the passage openings 21, 31 as a plurality of radially extending slits, the angle by which the valve plate 2 must be rotated in order to open or close respectively is comparatively small, e.g. less than 45°. This short path along which the valve plate 2 is rotated during the actuation likewise has a positive effect on the speed of the valve 1, that is, on the time required for the opening or closing respectively.

With respect to the theoretical design of the electric drive 4 with respect to its principle of operation there are numerous possibilities which are known per se. Thus the rotor 6 can for example be designed slit or unslit of a conducting material as an asynchronous short-circuit rotor, as a synchronous or step motor rotor with permanent magnets or as reluctance rotor, which comprises a ferromagnetic material. In regard to as mass-poor a design as possible the rotor 6 is preferably manufactured of a light material. Thus for example aluminium is a preferred material in the case of a short-circuit rotor. The electric drive 4 can naturally also be designed with an inwardly lying rotor 6, for example in that the arrangement of the stator 7 and the yoke 5 illustrated in FIGS. 1 and 2 is reversed.

The design of the journalling of the valve plate 2 and of the rotor 6 with respect to the carrier element 9 by means of bending springs 11 has the advantage that this journalling is free of play, abrasion and friction, in particular free of sliding friction. A high precision in the actuation of the valve 1 results from the play-free journalling so that a safe and reliable operation is ensured. The frictionless and abrasion-free journalling of the movable valve components, namely of the rotor 6 and the valve plate 2, leads to a very long lifetime. The active valve is practically abrasion-free in particular in connection with a design of the valve 1 in which the valve plate 2 executes a combined lifting-rotational movement, in which thus the actual valve movement also takes place substantially without friction between the valve plate 2 and the counter-plate 3.

The active actuation of the valve 1 in accordance with the invention enables the opening and closing time points to be set ideally in each case and in particular independently of the pressure exerted by the medium. This has the advantage that significantly lower energy losses arise, through which the efficiency of the valve 1 is improved. Furthermore, the performance of the compressor can be controlled in a very simple manner. Thus it is for example possible through the external control to leave the valve open during one or more work cycles in order thus to reduce the forwarding performance of the compressor in a simple manner depending on the requirements. If e.g. the pressure valve is left in the open position during every fourth work cycle, then the performance of the compressor is reduced by about 25%.

In particular the design of the valve 1 with the electric drive 4, which has a mass-poor, especially a tubular, rotor 6, leads to a very rapid valve; that is, the release or the blocking of the flow cross-section respectively by the valve 1 can take place in a very short time because the masses to be moved during the actuation are very small and thus only small inertial forces arise. This is a great advantage in particular in regard to very high performance compressors because in known valves the opening and closing times often represent an essential factor which limits the maximum working speed (piston speed) of the compressor which can be achieved.

As an alternative to the embodiment with the lifting magnet 10 the means for moving the valve plate 2 in the axial direction can also be integrated into the electric drive. The electric drive 4 is then designed in such a manner that it can exert an axially directed force on the rotor 6 or the valve plate 2 connected to it respectively in addition to the torque, for example through a corresponding arrangement and excitation of the windings 71 of the stator 7.

Naturally the bending springs 11 can also be designed differently, e.g. in such a manner that they extend in spiral shape between the rotor 6 or the valve plate 2 respectively and the carrier element 9 in the rest position.

Instead of the journalling of the rotor 6 and the valve plate 2 by means of the bending springs 11 it is also possible to journal the rotor 6 magnetically and without contact with respect to the carrier element 9. The journalling of the unit consisting of the rotor 6 and the valve plate 2 then takes place by means of magnetic bearings, which are known per se, e.g. by means of radial bearings, which hold the rotor 6 centered with respect to the longitudinal axis A of the valve. It is furthermore possible to integrate the means for the magnetic journalling into the electric drive 4, for example through a corresponding design and arrangement of the windings 71 of the stator 7 so that the electric drive can both exert a torque on the rotor 6 as well as journal the rotor magnetically and without contact in a manner which is centered with respect to the longitudinal axis A of the valve.

The non-contact magnetic journalling of the rotor 6 with respect to the carrier element 9 also brings with it the already mentioned advantage that it is free of friction and abrasion. In embodiments with a magnetic journalling of the rotor 6 or the valve plate 2 respectively it is also possible to rotate the valve plate 2 in the same direction in each case when opening and closing the valve 1.

It is evident that in the valve 1 in accordance with the invention a damper plate can additionally be provided between the valve plate 2 and the counter-plate 3, e.g. in a manner analogous to that which is known from conventional plate valves.

The valve 1 in accordance with the invention is distinguished in particular in that no rebounding and no fluttering of the valve plate 2 arises, through which a material fatigue is counteracted, so that the valve 1 has a very long lifetime in the operating state. The valve in accordance with the invention enables an excellent valve kinematics with short opening and closing times as well as with ideally settable opening and closing time points. Furthermore, the valve in accordance with the invention can be designed to be practically abrasion-free.

1. Actively controlled valve for a piston compressor comprising a valve plate (2) and a counter-plate (3), each of which has passage openings (21, 31), characterised in that the valve plate (2) is journalled in such a manner that it is rotatable about the longitudinal axis (A) of the valve and relative to the counter-plate (3); and in that a drive device (4) is provided which is rotationally fixedly connected to the valve plate (2) in order to rotate the latter relative to the counter-plate (3).

2. Valve in accordance with claim 1 in which the drive device is an electric drive (4) with a stator (7) and a rotor (6), with the rotor (6) being rotationally fixedly connected to the valve plate (2).

3. Valve in accordance with claim 2 in which the rotor (6) is designed as a mass-poor rotor (6), in particular as a tubular rotor (6).

4. Valve in accordance with one of the preceding claims, in which means are provided in order to move the valve plate (2) relative to the counter-plate (3) in the axial direction.

5. Valve in accordance with claim 4 in which the means for moving the valve plate (2) comprise a lifting magnet (10) which is arranged in such a manner that it can exert an axially directed force on the valve plate (2) and/or on the rotor (6).

6. Valve in accordance with claim 4 or claim 5 in which the electric drive (4) is designed in such a manner that it can exert an axially directed force on the rotor (6).

7. Valve in accordance with one of the claims 4 to 6 in which the valve plate (2) executes a combined lifting-rotational movement for the opening and/or the closing of the valve (1).

8. Valve in accordance with one of the claims 2 to 7 with the counter-plate (3), the valve plate (2) and the rotor (6) being arranged along a carrier element (9) which extends in the axial direction, with the journalling of the valve plate (2) and of the rotor (6) being designed to be abrasion-free, in particular frictionless, with respect to the carrier element (9).

9. Valve in accordance with claim 8 in which the rotor (6) is journalled magnetically and without contact with respect to the carrier element (9).

10. Valve in accordance with claim 8 in which the valve plate (2) and the rotor (6) are connected to the carrier element (9) by means of bending springs (11).

11. Piston compressor comprising a valve (1) which is designed in accordance with one of the preceding claims.
